(19) United States
(12) Patent Application Publication
(10) Pub. No.: US 2026/0087322 A1
(43) Pub. Date: Mar. 26, 2026

(54) GAN-BASED QUBO GENERATOR TOOL

(71) Applicant: Dell Products L.P., Round Rock, TX (US)

(72) Inventors: Diego Vrague Noble, Pelotas – RS (BR); Brendan Burns Healy, Haddonfield, NJ (US); Ítalo Gomes Santana, Rio de Janeiro – RJ (BR); Miguel Paredes Quiñones, Campinas – SP (BR)

(21) Appl. No.: 18/891,985

(22) Filed: Sep. 20, 2024

(51) Int. Cl. G06N 3/0475

(52) U.S. Cl. CPC G06N 3/0475

(57) ABSTRACT

One example method includes receiving a plurality of Quadratic Unconstrained Binary Optimization (QUBO) instances, the plurality of QUBO instances including at least first controllable features and their corresponding feature values and a first uncontrollable structure feature that defines a problem type of each of the plurality of QUBO instances. The first controllable features and the first uncontrollable structure feature of the received plurality of QUBO instances are used to train a QUBO generation machine-learning (ML) model to generate a QUBO instance. A QUBO feature set that includes second controllable features and their corresponding feature values and a second uncontrollable structure feature that defines a problem type of a new QUBO instance is received. The trained QUBO generation ML model generates the new QUBO instance that includes the second one or more controllable features and their corresponding feature values and the second uncontrollable structure feature.

### TECHNOLOGICAL FIELD OF THE DISCLOSURE

One or more embodiments disclosed herein generally relate to resolution of Quadratic Unconstrained Binary Optimization (QUBO) problems. More particularly, at least some embodiments relate to systems, hardware, software, computer-readable media, and methods, for using a machine-learning model to generate QUBOs that can be used in testing quantum annealing.

### BACKGROUND

Quantum Annealing (QA) is a technology that employs specialized hardware to solve computationally difficult optimization problems. This hardware leverages quantum effects such as quantum entanglement and quantum tunneling to accelerate the solving process of optimization problems. Typically, problems to be solved by the QA computer must be encoded in a QUBO format. Thus, to benchmark a QA computer, a set of QUBOs are needed. However, there is currently no unified or integrated approach to generate the set of QUBOs to be used in the benchmarking process.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIGS. 1A and 1B disclose aspects of upper triangular, and hashtable, representations of a QUBO and QUBO patterns.

FIG. 2 discloses aspects of a QUBO generation process for the so-called Traveling Salesperson Problem (TSP).

FIGS. 3A-3D disclose aspects of training a QUBO generation machine-learning (ML) model.

FIGS. 4A-4D disclose aspects of generating or modifying a QUBO instance using a trained QUBO generation ML model.

FIG. 5 discloses aspects of a cloud network where a QUBO generation ML model is implemented.

FIG. 6 discloses aspects of a method according to one embodiment.

FIG. 7 discloses aspects of a method according to one embodiment.

FIG. 8 discloses a computing entity configured and operable to perform any of the disclosed methods, processes, and operations.

### DETAILED DESCRIPTION OF SOME EXAMPLE EMBODIMENTS

One or more embodiments disclosed herein generally relate to resolution of Quadratic Unconstrained Binary Optimization (QUBO) problems. More particularly, at least some embodiments relate to systems, hardware, software, computer-readable media, and methods, for using a machine-learning model to generate QUBOs that can be used in testing quantum annealing.

One example method includes receiving a plurality of Quadratic Unconstrained Binary Optimization (QUBO) instances, the plurality of QUBO instances including at least first controllable features and their corresponding feature values and a first uncontrollable structure feature that defines a problem type of each of the plurality of QUBO instances. The first controllable features and the first uncontrollable structure feature of the received plurality of QUBO instances are used to train a QUBO generation machine-learning (ML) model to generate a QUBO instance. A QUBO feature set that includes second controllable features and their corresponding feature values and a second uncontrollable structure feature that defines a problem type of a new QUBO instance is received. The trained QUBO generation ML model generates the new QUBO instance that includes the second one or more controllable features and their corresponding feature values and the second uncontrollable structure feature.

One example method includes receiving a plurality of Quadratic Unconstrained Binary Optimization (QUBO) instances, the plurality of QUBO instances including at least first controllable features and their corresponding feature values and a first uncontrollable structure feature that defines a problem type of each of the plurality of QUBO instances. The first controllable features and the first uncontrollable structure feature of the received plurality of QUBO instances are used to train a QUBO generation machine-learning (ML) model to generate a QUBO instance. An existing QUBO instance that includes second controllable features and their corresponding feature values and a second uncontrollable structure feature that defines a problem type of a new QUBO instance is received. A QUBO modification dataset that specifies modifications that are to be made to one or more of the corresponding feature values of one or more of the second controllable features is received. The trained QUBO generation ML model generates a modified QUBO instance that is a modification of the existing QUBO instance and that includes the one or more of the second one or more controllable features whose corresponding feature values have been modified, other second controllable features whose corresponding feature values were not modified, and the second uncontrollable structure feature.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, advantageous aspects of the embodiments disclosed herein employ an advanced Generative Adversarial Network (GAN) based solution to generate new synthetic QUBO instances from any users initial QUBO in a way that the user can modify high-level features such as solving difficulty, qubit interdependency, modularity, size, and other metadata characteristics to generate new QUBOs benchmark instances. The purpose of benchmarking instances is generally related to testing performances of different solvers over disparate data distributions, in which the best performing solver, on average, is usually selected. When real-world data is not available, particularly in specific problem settings, the creation of synthetic data based on its real counterpart is crucial in running benchmarks. More specifically, the user can generate their own set of synthetic benchmark QUBOs that are closer to possible instances of a real problem and test them in multiple quantum annealer solvers. This will allow users to make better informed decisions about the computing resources they will use based on their own specific use-cases and selected solver.

### A. Context for an Example Embodiment

The following is a discussion of aspects of a context for various embodiments. This discussion is not intended to limit the scope of the claims or this disclosure, or the applicability of the embodiments, in any way.

Combinatorial optimization (CO) problems belong to a class of problems which aims at finding the best possible solution among a finite but extensive set of possible solutions. This set is usually exponential in size, making efforts in developing advanced algorithmic strategies even more crucial, especially when these problems are large and arise in real-world scenarios, that is, intricate configurations. QA is an emerging technique that leverages quantum effects, such as entanglement and tunneling, to accelerate the solving process of CO problems. When QAs are prohibitive, alternatives to QA, such as the Simulated QA (SQA) or Simulated Annealing (SA), can also be successful to solve CO problems in classical hardware.

For any of these CO solvers, it has been useful to solve these problems after they have been modelled into a mathematical format called Quadratic Unconstrained Binary Optimization (QUBO) or, in short, QUBO problems, or simply QUBOs. Problems in this format are first defined into a single Hamiltonian function that contains the objective function and constraints, therefore, avoiding the explicit definition of constraints as usually expressed in traditional formats as Mixed-Integer Linear Programming (MILP). After the definition of the Hamiltonian function, the input data is processed in a method called compilation to derive a n×n QUBO matrix, where n is the number of binary variables of the QUBO. In the QUBO matrix, each cell consists of a rational number as coefficient for each pair of binary variables, namely, one variable for the row and another variable for the column. An embodiment may leverage this simple notation to enable CO problems generated by resource-constrained devices to be solved into a robust machine, such as quantum or classical computing machine for example.

As used herein, the word QUBO can have two meanings depending on the context: (1) a QUBO is an abstract form that represents a form of encoding an optimization problem in the specific format described elsewhere herein; and (2) a QUBO problem instance or QUBO matrix is a concrete form, or instance, of an optimization problem encoded as a QUBO—this concrete form may be understood as a final stage before the problem is solved—in this stage, all coefficients and variables are defined. It is noted that both QUBOs and Ising models are equivalent through a polynomial transformation therefore an embodiment may adopt only the QUBO representation, for the sake of brevity.

### A.1 QUBOs

In the modeling of an optimization problem as a QUBO, an embodiment may have a pseudo-Boolean function ƒ: {0,1}ⁿ→ [symbol] such that the aim is to find one attribution x∈{0,1}ⁿ of binary values that minimizes the value of ƒ, that is,

$${min}_{x ∈ {\{ 0 , 1 \}}^{n}} f ( x ) ,$$

as disclosed in “E. Boros, P. L. Hammer and G. Tavares, ‘Preprocessing of Unconstrained Quadratic Binary Optimization,’ Rutgers University, Piscataway, New Jersey, 2006,” which is incorporated herein in its entirety by this reference.

The function ƒ is of degree at most two, and is usually defined as a summation of linear and quadratic terms in the form:

$$\begin{matrix}f ( {x}_{1} , … , {x}_{n} ) = {c}_{0} + {{\sum }^{n}}_{j = 1} {c}_{j} {x}_{j} + {{\sum }^{n}}_{i = 1} {{\sum }^{n}}_{j = i + 1} {c}_{ij} {x}_{i} {x}_{j} \\ QUBO general form\end{matrix} \qquad Equation 1$$

In this form, c₀ is called the offset while the cᵢ for i=1, . . . , n terms are called linear terms and the cᵢⱼ for 1≤i<j≤n terms are called the quadratic terms. Each input—that is, each variable assignment for all variables—to this function has a corresponding energy value, thus the QUBO optimization problem can be expressed alternatively as

$${min}_{x ∈ {\{ 0 , 1 \}}^{n}} {xQx}^{T}$$

such that Q∈ [symbol] ^{{n×n}}. The symmetric matrix Q is usually referred to itself as the QUBO.

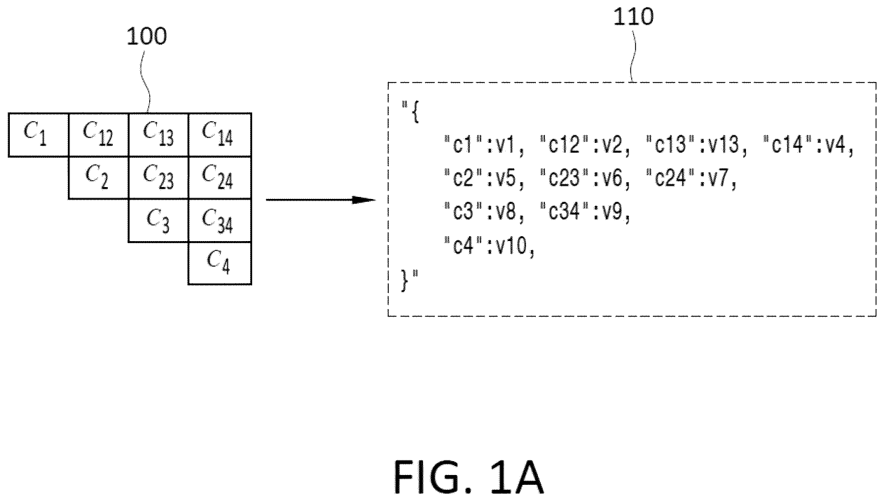

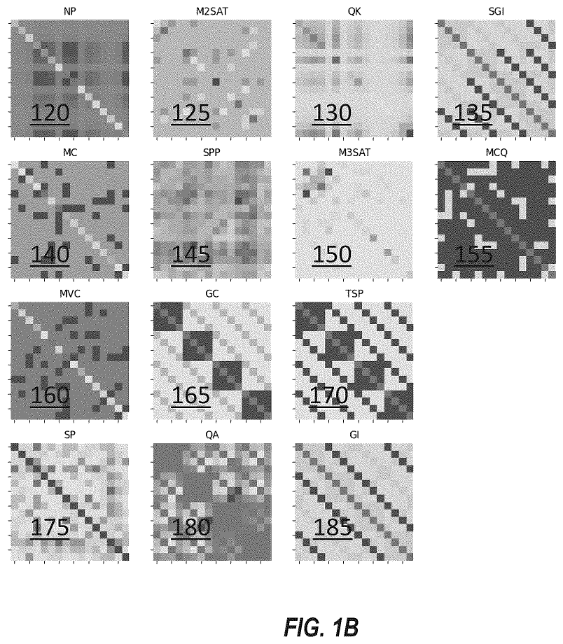

When modelling problems using the QUBO format, there are two commonly used representations: the symmetric matrix or the upper triangular matrix. The upper triangular matrix representation is preferred when one seeks to avoid transmitting or storing redundant information while the symmetric matrix representation is preferred when solving or manipulating the QUBO itself. An example of an upper triangular matrix 100 is depicted in FIG. 1A. This representation can also be transformed into a hashtable, or dictionary, such as the example hashtable 110 depicted in FIG. 1A. In particular, the upper triangular matrix 100 and hashtable 110 are forms of representing a QUBO and are interchangeable. The placeholders v1, v2, . . . v10 represent the floating-point coefficient values themselves.

The value of each coefficient is a floating point that depends on how the input instance of the problem and the problem's objective function was translated into the QUBO format. The first step is to produce a valid mathematical representation of problem's objective function and constraints that can be converted to Equation 1. Various representations for classic optimization problems may be found in “A. Lucas, ‘Ising formulations of many NP problems,’ Frontiers in Physics, vol. 2, 2014,” which is incorporated herein in its entirety by this reference.

Another aspect of QUBOs is that different patterns can be seen in the QUBO matrix associated with different optimization problems. These different patterns are inherited from the optimization problem's structure itself. Thus, each instance of a QUBO may resemble similar instances of the same problem or even similar derived problems.

FIG. 1B illustrates the richness of patterns that different optimization problems can have when translated into QUBOs. For example, the QUBO matrix associated with number partitioning (NP) optimization problem is shown at 120. The QUBO matrix associated with the Max2Sat (M2SAT) optimization problem is shown at 125. The QUBO matrix associated with the Quadratic Knapsack (QK) optimization problem is shown at 130. The QUBO matrix associated with the Subgraph Isomorphism (SI) optimization problem is shown at 135. The QUBO matrix associated with the MaxCut (MC) optimization problem is shown at 140. The QUBO matrix associated with the Set Partitioning (SPP) optimization problem is shown at 145. The QUBO matrix associated with the Max3SAT (M3SAT) optimization problem is shown at 150. The QUBO matrix associated with the Maximum Clique (MCQ) optimization problem is shown at 155. The QUBO matrix associated with the Minimum Vertex Cover (MVC) optimization problem is shown at 160. The QUBO matrix associated with the Graph Coloring (GC) optimization problem is shown at 165. The QUBO matrix associated with the Traveling Salesperson Problem (TSP) optimization problem is shown at 170. The QUBO matrix associated with the Set Packing (SP) optimization problem is shown at 175. The QUBO matrix associated with the Quadratic Assignment optimization problem is shown at 180. The QUBO matrix associated with the Graph Isomorphism (GI) optimization problem is shown at 185. As can be seen from FIG. 1B, different optimization problems may have similar patterns even though they are different, such as Graph Coloring (GC) 165 and Traveling Salesperson Problem (TSP) 170.

### A.2 Quantum Annealing

With this mathematical representation, a process called compilation is executed to combine the mathematical definition along with the problem's instance input to produce a QUBO upper, or lower, triangular matrix. Next, a quantum annealer, or a simulated quantum annealer, may use this upper triangular matrix to find the variable assignment x that minimizes the energy of that QUBO. The mathematical representation is constant for a given problem configuration.

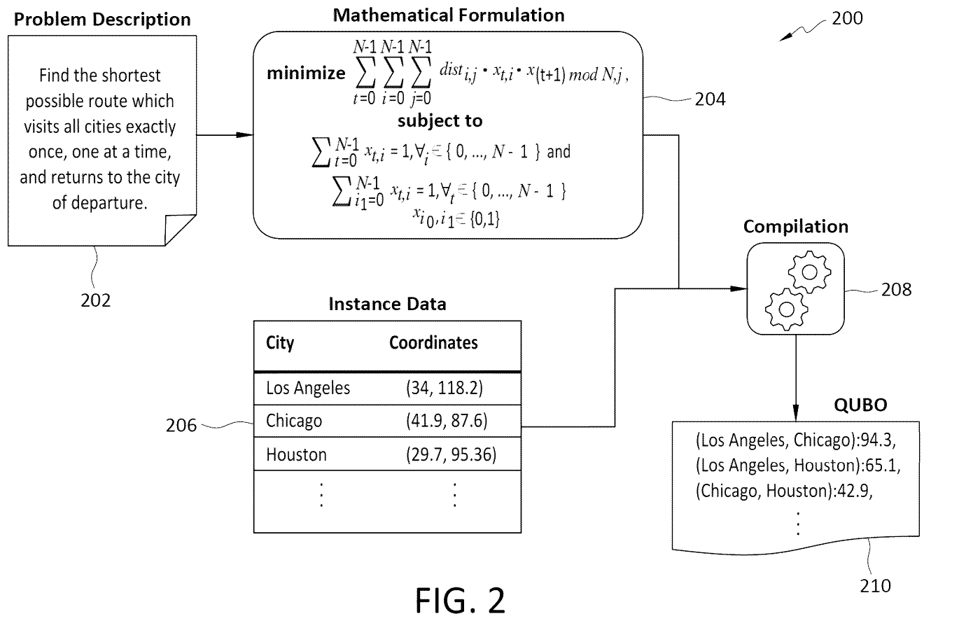

FIG. 2 illustrates this whole process, denoted at 200, using the Traveling Salesperson Problem (TSP) 170, which is a combinatorial optimization problem that can be modeled as QUBO. An initial problem description 202 is given, resulting into a valid mathematical formulation 204 for TSP. Next, the instance input, or instance data 206, for the problem is also given and compiled using the valid mathematical formulation to generate a compilation 208, therefore, producing an upper triangular matrix. A solution 210 to the QUBO may then be generated using the compilation 208. It is noted with respect to the example of FIG. 2, each set of instance data 206 must compile independently so as to generate a respective new QUBO. The values in FIG. 2 are placeholders only and variable names used were city names.

Solving an arbitrary QUBO, that is, finding a global minimum in an energy function, is an NP-hard problem, which is a class of problems that is not known to be solvable by exact methods in polynomial time on deterministic machines such as in classical computers. QUBOs can be solved heuristically using quantum annealing, a technique that leverages quantum phenomena such as quantum entanglement and quantum tunneling to explore the space of possible assignments more effectively in a specialized hardware.

### B. Overview of Aspects of One or More Embodiments

### B.1 Introduction

Tasks related to generating synthetic benchmark instances to evaluate (simulated) annealing solvers are commonly challenging due to the complexity of creating scripts for generating instances and their validation. This becomes further complicated when testing benchmarks at large scale with many variable features in these instances. This reduces not only the accuracy in the performance evaluation of solvers, but also the faithfulness in the true expectation in the generated instances. In addition, identification and reproduction of complex patterns seen in real-word QUBO instances are tasks that are not always trivial and, therefore, require specialized techniques rather than mimic ones.

As will be explained in more detail to follow, the embodiments disclosed herein solve these problems by performing a two-step process:
1. Data Acquisition and Training: This is a step where one or more QUBO instances are fed in as training data to a QUBO generation machine-learning model such as a Generative Adversarial Network (GAN) together with metadata about their features (e.g., size, problem difficulty, coefficient interdependency, QUBO variables connectivity, etc.). In one embodiment this process can be executed using a two-phase controllable GAN.
2. Benchmark Dataset Generation: This step is executed iteratively to build a benchmark dataset with desired features. This step can operate in two modes: generation or editing. In the generation mode, all that is necessary to generate a QUBO are the desired features and their corresponding values. In the editing mode, one needs, in addition to the features and their values, to provide a QUBO which will have its features changed.

### B.2 Data Acquisition and Training

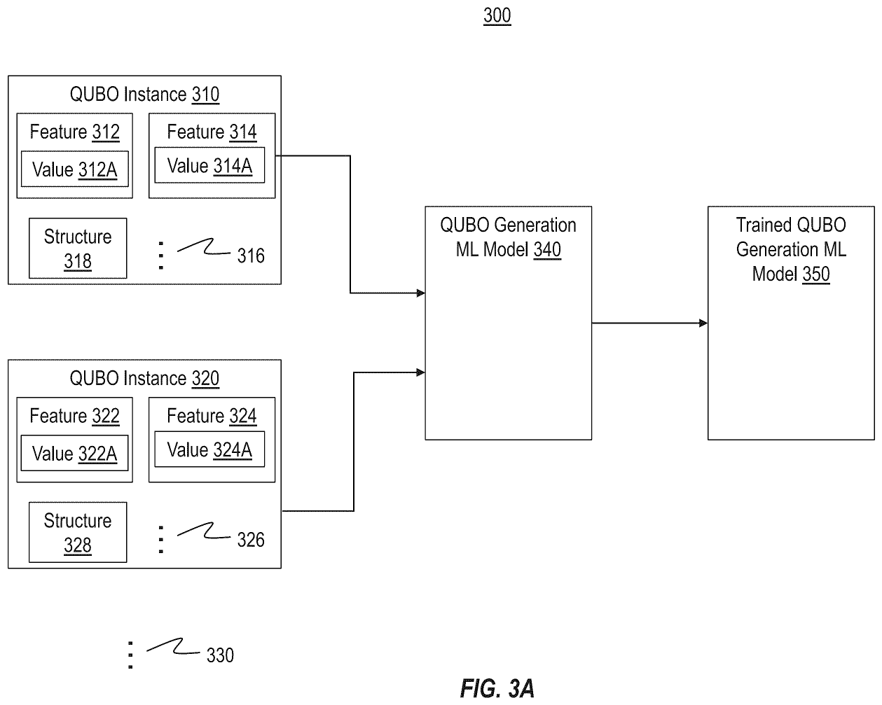

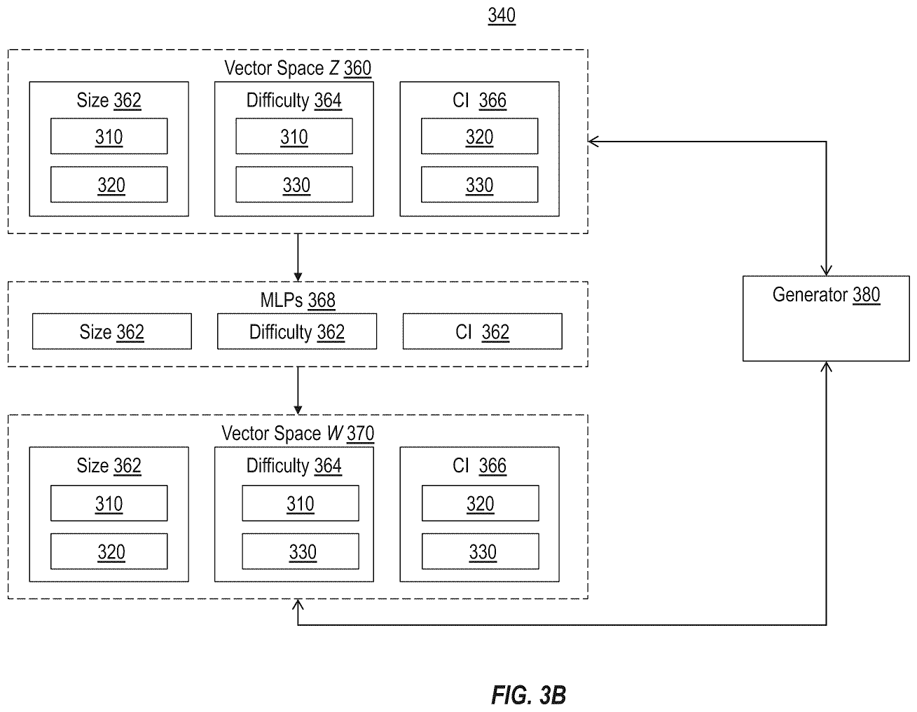

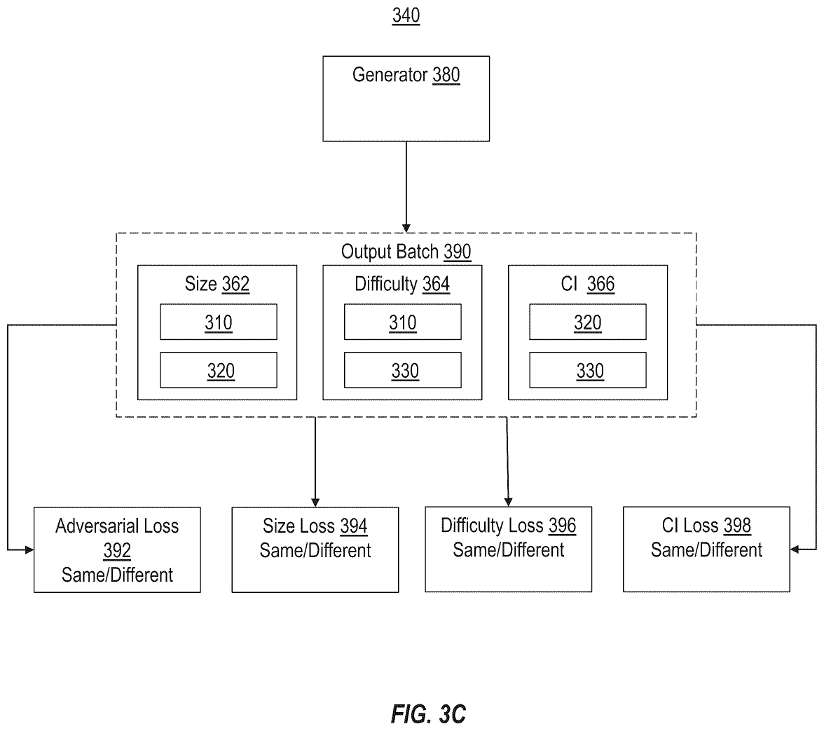

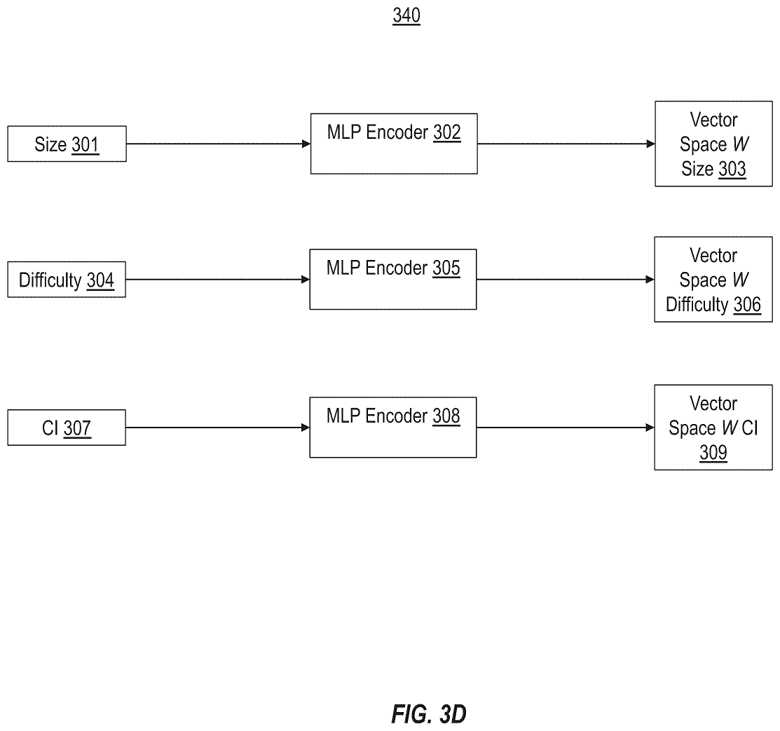

FIGS. 3A-3D illustrate an environment 300 where the embodiments disclosed herein may be practiced. In particular, the environment 300 may be used to train a QUBO generation machine-learning (ML) model that can then be used to generate QUBO instances as needed.

As illustrated in FIG. 3A, the environment 300 includes a QUBO instance 310, a QUBO instance 320, and any number of additional QUBO instances 330 as illustrated by the ellipses. As further illustrated, each of the QUBO instances includes various features (or at least metadata about their features) and values for each of the features. For example, the QUBO instance 310 includes a feature 312 having a value of 312A, a feature 314 having a value of 312A, and any number of additional features 316 with corresponding values as illustrated by the ellipses. The features 312, 314, and 316 are considered to be controllable features as they can be selected and changed as will be explained in more detail to follow. In one embodiment, the features 312, 314, and 316 may include, but are not limited to, QUBO size, QUBO problem difficulty, QUBO coefficient interdependency, and QUBO variable connectivity. Of course, other QUBO related features may also be included in one or more the QUBO instances. As mentioned, each feature includes a value such as values 312A or 312B. For example, in one embodiment the QUBO problem difficulty feature may have a value 312A or 312B of 0.5, the QUBO size feature may have a value 312A or 312B of 3600, and the QUBO coefficient interdependency feature may have a value 312A or 312B of 0.25.

The QUBO instance 310 also includes a structure feature 318 that defines a structure of the QUBO based on the QUBO problem type. For example, if the QUBO instance was a Max3SAT optimization problem as shown at 150, it would have one type of structure feature 318 and if it were the TSP optimization problem as shown at 170 it would have another structure feature 318. Thus, the structure feature 318 will be different for each of the QUBO patterns 120-185 discussed previously. The structure feature 318 is considered an uncontrollable feature as the structure is defined by the QUBO problem type and thus is not selectable or changeable.

Likewise, the QUBO instance 320 includes a feature 322 having a value of 322A, a feature 324 having a value of 324A, and any number of additional features 326 with corresponding values as illustrated by the ellipses that correspond to the features 312, 314, and 316 and the feature values 312A and 314A. The QUBO instance 320 also includes a structure feature 328 that defines a structure of the QUBO based on the QUBO problem type. Thus, the structure feature 328 will be different for each of the QUBO patterns 120-185 discussed previously. Although not illustrated, any of the additional QUBO instances 330 would also have features with corresponding values and a structure feature.

The environment 300 also includes a QUBO generation ML model 340. In one embodiment, the QUBO generation ML model 340 is any reasonable Generative Adversarial Network (GAN) based model or algorithm that allows for the use of controllable features. One such GAN based model or algorithm is described in “A. Shoshan, N. Bhonker, I. Kviatkovsky, and G. Medioni, “GAN-Control: Explicitly Controllable GANs,” in 2021 IEEE/CVF International Conference on Computer Vision (ICCV), Montreal, QC, Canada: IEEE, October 2021, pp. 14063-14073,” which is incorporated herein in its entirety by this reference, which is a variant of an advanced GAN based model or algorithm called StyleGAN, which is described in “T. Karras, M. Aittala, J. Hellsten, S. Laine, J. Lehtinen, and T. Aila, “Training Generative Adversarial Networks with Limited Data,” in Advances in Neural Information Processing Systems, Curran Associates, Inc., 2020, pp. 12104-12114”, which is incorporated herein in its entirety by this reference. This GAN based model or algorithm processes input as images to generate new ones with predefined characteristics, such as changing picture style, makeup, object position, or other attributes. This is fully compatible with a QUBO because a QUBO is matrix, like an image, with continuous numerical values.

In operation, the QUBO generation ML model 340 receives the QUBO instance 310, QUBO instance 320, and potentially any number of the additional QUBO instances 330 as training data. The QUBO generation ML model 340 then performs a training process using the received QUBO instances 310, 320, and 330. This results in a trained QUBO generation ML model 350. As will be explained in more detail to follow, the trained QUBO generation ML model 350 is able to receive feature sets related to QUBO instances and then to generate new QUBO instances and/or modify existing QUBO instances.

FIGS. 3B-3D illustrate an embodiment of the QUBO generation ML model 340 while performing a two-step or phase training process. In particular, FIGS. 3B-3C illustrate the first step of the process and FIG. 3D illustrates the second step of the process. In the first step, the QUBO generation ML model 340, which may be a GAN, is trained so that for each feature, there is a respective sub-space in both latent vector spaces [symbol] and [symbol] so each sub-space encodes a different feature. More specifically, supposing that there are N features, [symbol] and [symbol] will have N+1 subspaces. Each of the N subspaces is a controllable feature to a QUBO (e.g., size, difficulty, etc.). The last subspace is an uncontrollable feature, which is the QUBO structure itself. This guarantees that features are disentangled from each other during the training.

A specific example of the first step in the training process will now be described. As illustrated in FIG. 3B, in the embodiment the QUBO generation ML model 340 receives the QUBO instances 310, 320, and 330 as previously described. The features of the QUBO instances are then mapped into the latent vector space [symbol] 360. The latent vector space [symbol] 360 and a latent vector space [symbol] 370 are high-dimensional universal spaces in which each QUBO exists. They are vector spaces where the elements of the vectors correspond to the features of the QUBOs.

In addition to mapping the features of the QUBO instances into the latent vector space [symbol] 360, a generator 380 generates matching pairs of the QUBO instances having a given feature, even though the other features of the QUBO instances may not be the same. For example, for a QUBO size feature 362 the generator 380 generates a pair including the QUBO instances 310 and 320. In other words, even though the other features of the QUBO instances 310 and 320 may be different, these two QUBO instances each include the QUBO size feature 362. In like manner, the generator 380 generates a pair including the QUBO instance 310 and one of the additional QUBO instances 330 that each include a QUBO problem difficulty feature 364 and generates a pair including the QUBO instance 320 and one of the additional QUBO instances 330 that each include a QUBO coefficient interdependency (CI) feature 366. Although not illustrated, the generator 380 also generates pairs of QUBO instances that both additional controllable features and the uncontrollable structure feature.

The matching pairs of the features are then mapped from the latent vector space [symbol] 360 to the latent vector space [symbol] 370 as shown in FIG. 3B. This mapping is performed by a mapping network composed of Fully-Connected Multilayer Perceptrons (MLPs) 368. This mapping to the latent vector space [symbol] 370 is performed in the embodiment because latent space [symbol] 360 improves the representation and feature disentanglement.

As illustrated in FIG. 3C, an output batch 390 is generated that includes the matching pairs of the features that have been mapped into the latent space [symbol] 370. For the output batch 390, an adversarial loss 392 is determined. The adversarial loss is a property of the GAN model. In addition, each QUBO instance in the output batch 390 is compared in a contrastive manner, feature-by-feature, to all others to thereby determine a QUBO size feature loss 394, a QUBO difficulty feature loss 396, and a QUBO CI feature loss 398. In other words, during the comparison in a contrastive manner, a determination is made if the feature pairs are the same or different, and from this, various losses can be determined. This process trains the QUBO generation ML model 340 to understand the meaning of each of the QUBO features that can then be used in future QUBO instance generation.

In the second step of the training process, for each feature, an MLP encoder is trained to map the features to their corresponding latent vector space. This mapping is a function that maps how each feature should affect the corresponding latent vector space. In other words, the MLPs are used to change the noise in the latent vector space in a way that corresponds to the change in the features. This is why one MLP encoder should be trained for each controllable feature.

A specific example of the second step of the training process will now be described. As illustrated in FIG. 3D, a controllable QUBO size feature 301 is provided to a MLP encoder 302. The MLP encoder 302 is trained to recognize the QUBO size feature 301 and to map the QUBO size feature 301 to a latent vector space [symbol] QUBO size feature 303. Likewise, a controllable QUBO difficulty feature 304 is provided to a MLP encoder 305. The MLP encoder 305 is trained to recognize the controllable QUBO difficulty feature 304 and to map the controllable QUBO difficulty feature 304 to a latent vector space [symbol] QUBO difficulty feature 306. Further, a controllable QUBO CI feature 307 is provided to a MLP encoder 308. The MLP encoder 308 is trained to recognize the controllable QUBO CI feature 307 and to map the controllable QUBO CI feature 307 to a latent vector space [symbol] QUBO CI feature 309. Although not illustrated, in some embodiments the controllable features are first mapped to the latent vector space [symbol] before being mapped to the latent vector space [symbol] .

### B.3 Benchmark Dataset Generation

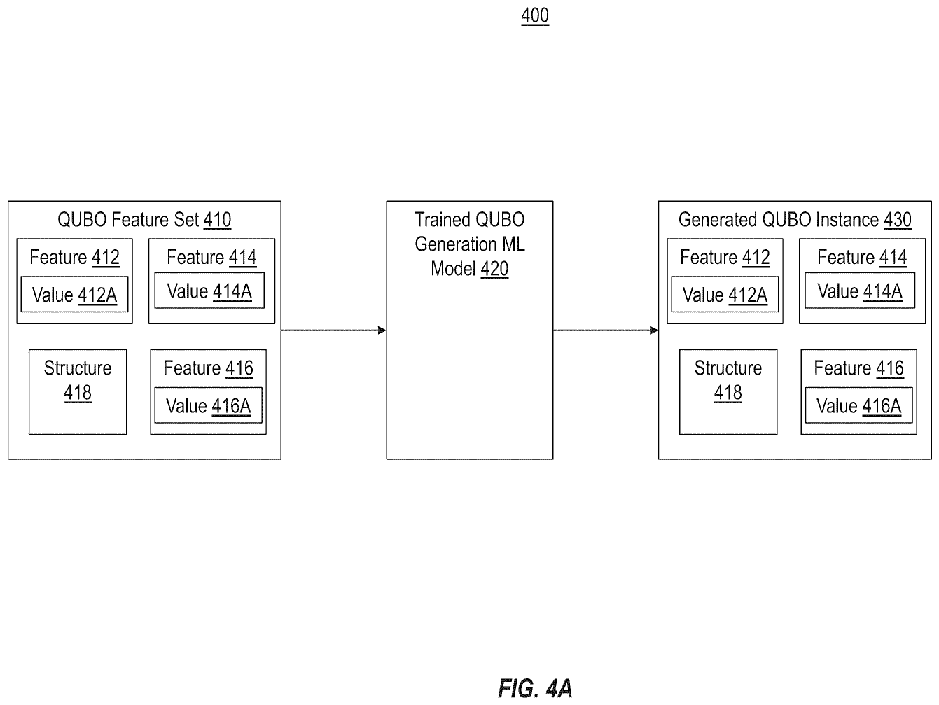

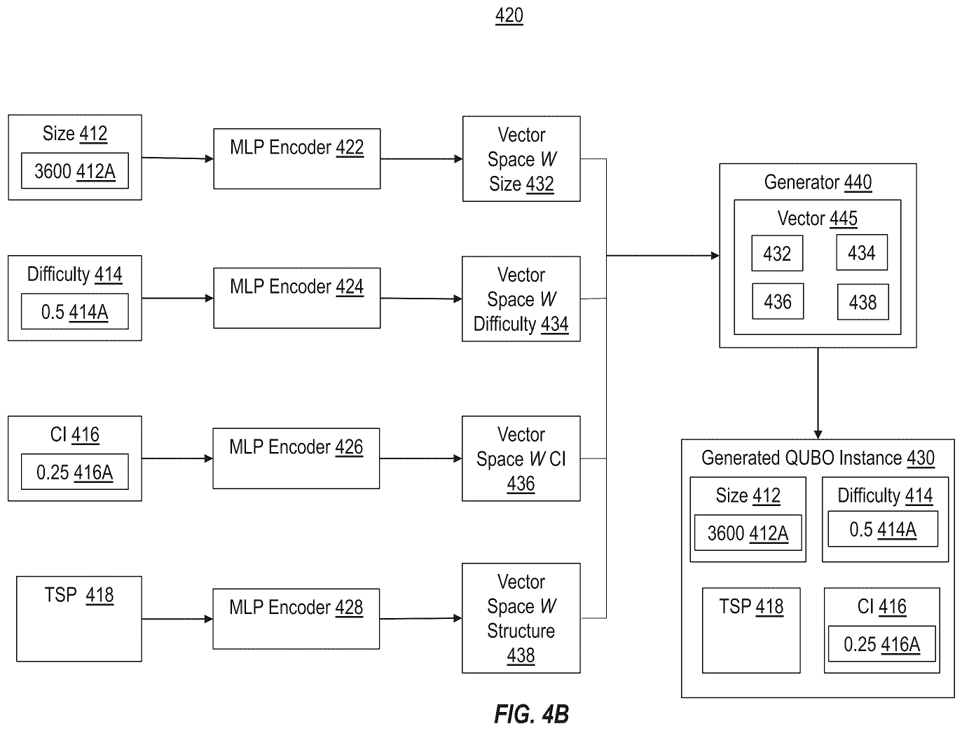

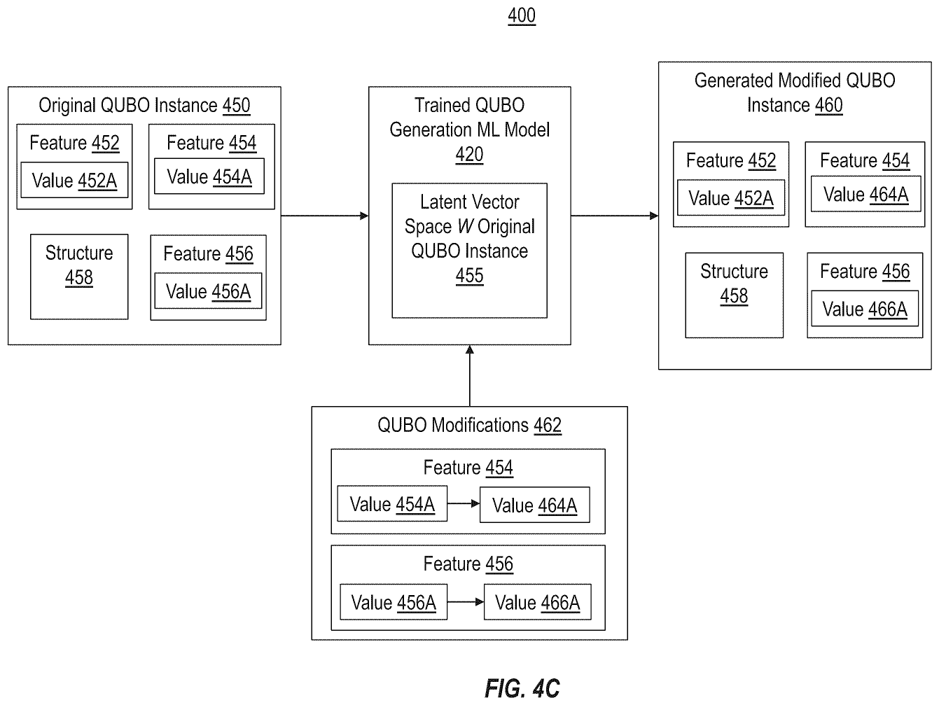

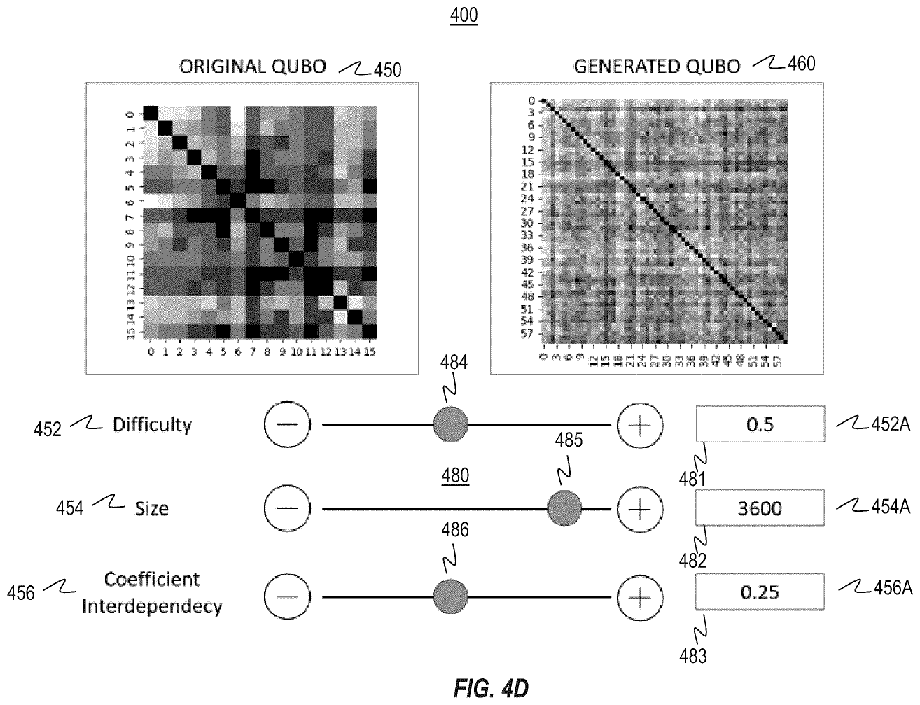

FIGS. 4A-4D illustrate an environment 400 where the embodiments disclosed herein may be practiced. In particular, the environment 400 uses a QUBO generation machine-learning (ML) model that has been trained in the manner previously described herein to generate a new QUBO instance (FIGS. 4A-4B) or to modify an existing QUBO instance (FIGS. 4C-4D).

FIG. 4A illustrates a feature set 410 that is provided to a trained QUBO generation ML model 420 that has been trained in the manner previously described herein and that corresponds to the QUBO generation ML models 340 and 350 previously described. The feature set 410 is provided by a user who inputs the feature set as a string of values or who uses an interface designed to entry the feature set 410.

In the embodiment the feature set 410 includes a feature 412 having a value of 412A, a feature 414 having a value of 414A, and a feature 416 having a value of 416A. Although not illustrated, the feature set may also include any number of additional features as circumstances warrant. The features 412, 414, and 416 correspond to the features 312, 314, and 316 previously discussed and the values 412A, 414A, and 416A correspond to the values 312A, 314A, and 316A. The feature set 410 also includes a structure feature 418 that corresponds to the structure feature 318 previously discussed and that defines a structure of a desired QUBO that will be generated based on the QUBO problem type.

Upon receiving the feature set 410, the trained QUBO generation ML model 420 performs a QUBO generation operation that results in the generation of a generated QUBO instance 430. As illustrated, the generated QUBO instance 430 includes the feature 412 having the value of 412A, the feature 414 having the value of 414A, and the feature 416 having the value of 416A. In addition, generated QUBO instance 430 includes the structure feature 418. Thus, if the structure feature 418 defined the Traveling Salesperson Problem (TSP) 170, then the generated QUBO instance 430 would be a TSP.

FIG. 4B illustrates an embodiment of a generation process when the trained QUBO generation ML model 420 corresponds to the QUBO generation ML models 340 and 350 previously described. In particular, in the embodiment the trained QUBO generation ML model 420 includes MLP encoders that have been trained in the manner described previously in FIG. 3D. In the embodiment, the feature 412 is a controllable QUBO size feature having a value 412A of 3600, the feature 414 is a controllable QUBO difficulty feature having a value 414A of 0.5, the feature 416 is a controllable QUBO CI feature having a value 416A of 0.25, and the structure feature 418 is TSP.

Accordingly, as illustrated the controllable QUBO size feature 412 is provided to a MLP encoder 422. The MLP encoder 422 is trained to recognize the QUBO size feature 412 and to map the QUBO size feature 412 to a latent vector space [symbol] QUBO size feature 432. Likewise, the controllable QUBO difficulty feature 414 is provided to a MLP encoder 424. The MLP encoder 424 is trained to recognize the QUBO difficulty feature 414 and to map the QUBO difficulty feature 414 to a latent vector space [symbol] QUBO difficulty feature 434. Further, the controllable QUBO CI feature 416 is provided to a MLP encoder 426. The MLP encoder 426 is trained to recognize the QUBO CI feature 416 and to map the QUBO CI feature 416 to a latent vector space [symbol] QUBO CI feature 436. As further illustrated, the structure feature 418 is provided to a MLP encoder 428 that maps the structure feature 418 to a latent vector space [symbol] structure feature 438.

With the features and their corresponding values being in the latent vector space [symbol] , a generator 440 is able to generate the generated QUBO instance 430. In one embodiment, the generator 440 combines the features and their corresponding values in a vector 445 in the latent vector space [symbol] .

In the embodiment, the generated QUBO instance 430 includes the size feature with a value of 3600, the difficulty feature with a value of 0.5, and the CI feature with a value of 0.25. The generated QUBO instance 430 is also a TSP QUBO. The generated QUBO instance 430 and any number of additional QUBOs generated in the same manner can be used to bench test one or more quantum annealers as circumstances warrant.

FIG. 4C illustrates an embodiment of modifying an original QUBO instance when the trained QUBO generation ML model 420 corresponds to the QUBO generation ML models 340 and 350 previously described. As illustrated in FIG. 4C, an original QUBO instance 450 includes a feature 452 having a value of 452A, a feature 454 having a value of 454A, and a feature 456 having a value of 456A. Although not illustrated, the original QUBO instance 450 may also include any number of additional features as circumstances warrant. The features 452, 454, and 456 correspond to any of the features previously discussed and the values 452A, 454A, and 456A correspond to any of the values previously described. The original QUBO instance 450 also includes a structure feature 458 that corresponds to any of the structure features previously discussed and that defines a structure of the original QUBO instance 450. The original QUBO instance 450 (or at least the features 452, 454, and 456 and their corresponding values 452A, 454A, and 456A) is provided to the trained QUBO generation ML model 420. In one embodiment, the original QUBO instance 450 is reconstructed into a latent vector space [symbol] original QUBO instance 455.

After the original QUBO instance is reconstructed into the latent vector space [symbol] , QUBO modifications 462 are provided by a user to the trained QUBO generation ML model 420. As illustrated, the QUBO modifications 462 show that the feature 454 has had its value 454A modified to a value 464A. For example, suppose that the feature 454 is QUBO size and the value 454A is 3600. In the embodiment, the value 454A of 3600 is modified to a value 464A of 3700. Likewise, the QUBO modifications 462 show that the feature 456 has had its value 456A modified to a value 466A. For example, suppose that the feature 456 is QUBO difficulty and the value 456A is 0.5. In the embodiment, the value 456A of 0.5 is modified to a value 466A of 0.6.

Upon receipt of the QUBO modifications 462, the trained QUBO generation ML model 420 generates a modified QUBO instance 460. In the embodiment, the generated modified QUBO instance 460 includes the feature 452 with value 452A and the structure feature 458 from the original QUBO instance 450 and also includes the features 454 and 456 with their respective modified values 464A and 466A. The generated modified QUBO instance 460 and any number of additional QUBOs modified in the same manner can be used to bench test one or more quantum annealers as circumstances warrant.

FIG. 4D illustrates an embodiment of an example of a user interface 480 that can be used to provide the QUBO modifications 462 to the trained QUBO generation ML model 420. Other graphical interfaces or elements can be used to achieve the same effect, for instance. In FIG. 4D, the original QUBO instance 450 is provided to the trained QUBO generation ML model 420 and is reconstructed into the latent vector space [symbol] original QUBO instance 455. In the embodiment, the QUBO difficulty feature 452 is initially shown as having a value 452A of 0.5 displayed in a user interface display element 481 of the user interface 480, the QUBO size feature 454 is initially shown as having a value 452A of 3600 displayed in a user interface display element 482 of the user interface 480, and the QUBO CI feature 456 is initially shown as having a value 456A of 0.25 displayed in a user interface display element 483 of the user interface 480.

The user interface 480 also includes value modification elements 484, 485, and 486 that allow a user to modify the feature values 452A, 454A, and/or 456A. For example, if a user desires to modify the difficulty feature value 452A, he or she can move the modification element 484 left toward the “−” element to lower the value or right toward the “+” element to increase the value. Once the desired value is shown in the user interface display element 481, the modified value becomes part of the QUBO modifications 462. Likewise, if a user desires to modify the size feature value 454A, he or she can move the modification element 485 left toward the “−” element to lower the value or right toward the “+” element to increase the value. Once the desired value is shown in the user interface display element 482, the modified value becomes part of the QUBO modifications 462. In addition, if a user desires to modify the coefficient intendency feature value 456A, he or she can move the modification element 486 left toward the “−” element to lower the value or right toward the “+” element to increase the value. Once the desired value is shown in the user interface display element 483, the modified value becomes part of the QUBO modifications 462.

The QUBO modifications 462 are then provided to the trained QUBO generation ML model 420 and the generated modified QUBO instance 460 is automatically generated. Thus, the user interface 480 provides for an easy way for the user to generate numerous modified QUBO instances as the user can change quickly and easily one or more of the feature values until a desired number of QUBO instances have been modified. Depending on the computing system being used for inference, changes can be observed immediately or they can take some time likewise in a photo edition software environment.

### B.4 Further Embodiments

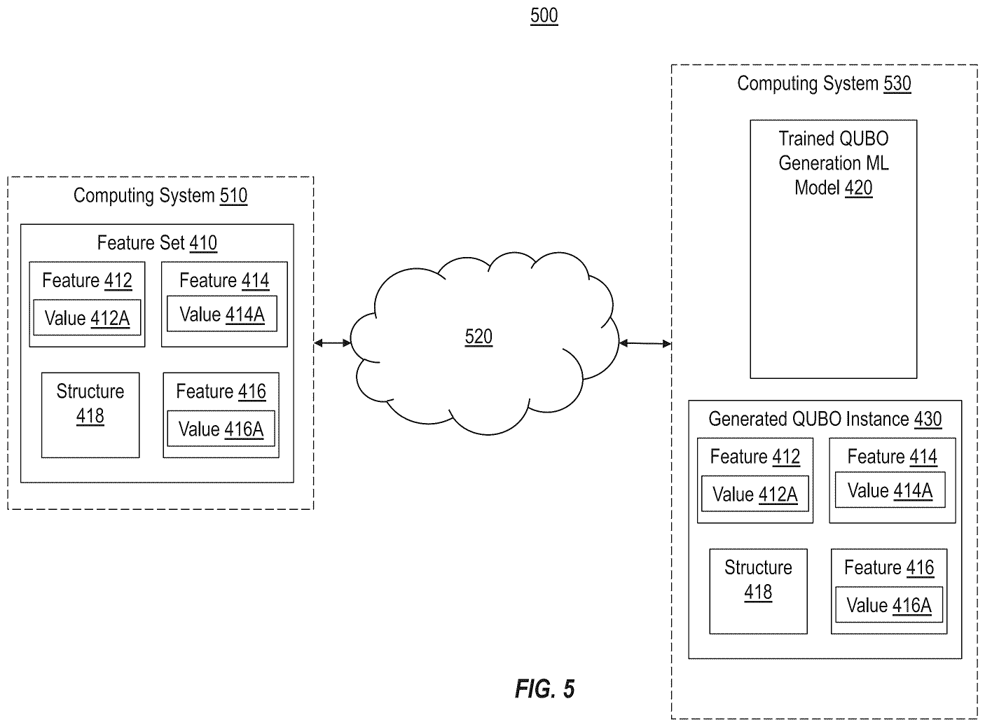

FIG. 5 illustrates an environment 500 where further embodiments disclosed herein may be practiced. As illustrated, the environment 500 includes a computing system 510 and a computing system 530 that are connected to each other via a cloud network 520 or other remote network system. In the embodiment, the computing system 510 may be considered a computing system that is local to user and the computing system 530 may be considered a computing system that is remote to the user.

The user may generate in the computing system 510 the feature set 410 previously described and may provide the feature set 410 includes its features and feature values to computing system 530 via the cloud network 520. As illustrated, the computing system 530 hosts the trained QUBO generation ML model 420 previously described.

Once the computing system 530 receives the feature set 410, the trained QUBO generation ML model 420 can generate the generated QUBO instance 430 in the manner previously described. The generated QUBO instance 430 is then returned to the computing system 510 via the cloud network 520 for use by the user of the computing system in benchmark testing of the quantum annealer or any other desired use.

Accordingly, the environment 500 allows for a computing system 530 to be owned and operated by a service that can generate and/or modify QUBO instances based on the feature set 410 provided from the computing system 510 and other feature sets provided by other user's computing systems. Since the computing system 530 is remote from the computing system 510 or other user computing systems, the service can keep secret its specific trained QUBO generation ML model 420 while still providing generated and modified QUBO instances to using the data provided by the users. In addition, this also alleviates the need for the local computing system 510 to host a trained QUBO generation ML model 420 and to use computing resources needed to perform a QUBO generation or modification process. Rather, the computing system 510 can host the user interface 480 or like interface that allows user to quickly and easily generate the feature set 410 for use by the computing system 530 during the QUBO generation or modification process.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

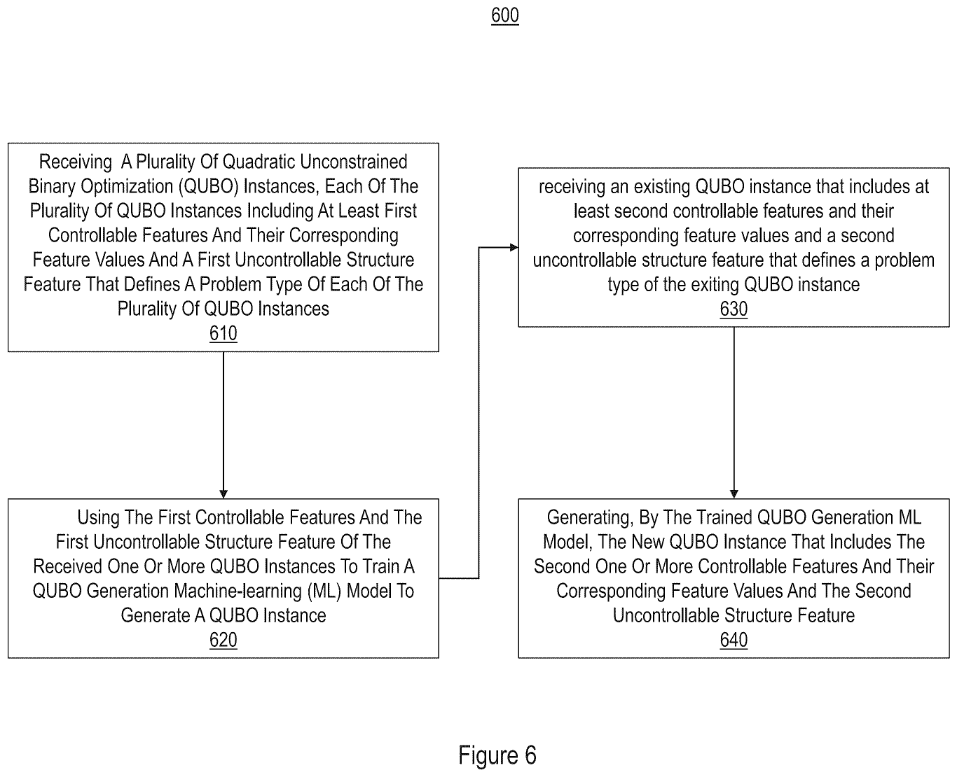

Directing attention now to FIG. 6, an example method 600 is disclosed. The method 600 will be described in relation to one or more of the figures previously described, although the method 600 is not limited to any particular embodiment.

The method 600 includes receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances (610). For example, as previously described the QUBO instances 310, 320 and 330 are received. The QUBO instance 310 includes the controllable features 312, 314, and 316 with their corresponding feature values 312A, 312B, and the non-illustrated feature values for the controllable feature 316. The QUBO instance 310 also includes the non-controllable structure feature 318. The QUBO instance 320 includes the controllable features 322, 324, and 326 with their corresponding feature values 322A, 322B, and the non-illustrated feature values for the controllable feature 326. The QUBO instance 320 also includes the non-controllable structure feature 328.

The method 600 includes using the first controllable features and the first uncontrollable structure feature of the received plurality of QUBO instances to train a QUBO generation machine-learning (ML) model to generate a QUBO instance (620). For example, as previously described the QUBO instances 310, 320 and 330 are used to train the QUBO generation ML model 340, which can be a GAN model, so that it become the trained QUBO generation ML model 350. The training process may be as described in FIGS. 3B-3D.

The method 600 includes receiving a QUBO feature set that includes second controllable features and their corresponding feature values and a second uncontrollable structure feature that defines a problem type of a new QUBO instance (630). For example, as previously described the QUBO feature set 410 is received by the trained QUBO generation ML model 420.

The method 600 includes generating, by the trained QUBO generation ML model, the new QUBO instance that includes the second controllable features and their corresponding feature values and the second uncontrollable structure feature (640). For example, as previously described the trained QUBO generation ML model 420 generates the generated QUBO instance 430. The generated QUBO instance 430 may be generated as described in relation to FIG. 4B.

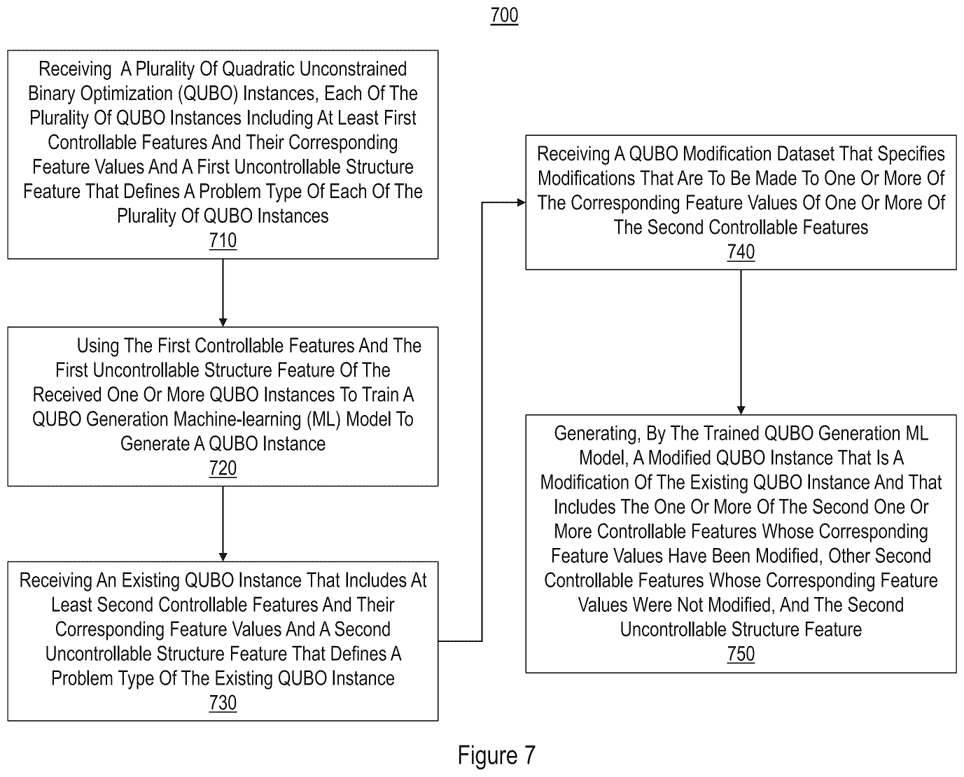

Directing attention now to FIG. 7, an example method 700 is disclosed. The method 700 will be described in relation to one or more of the figures previously described, although the method 700 is not limited to any particular embodiment.

The method 700 includes receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances (710). For example, as previously described the QUBO instances 310, 320 and 330 are received. The QUBO instance 310 includes the controllable features 312, 314, and 316 with their corresponding feature values 312A, 312B, and the non-illustrated feature values for the controllable feature 316. The QUBO instance 310 also includes the non-controllable structure feature 318. The QUBO instance 320 includes the controllable features 322, 324, and 326 with their corresponding feature values 322A, 322B, and the non-illustrated feature values for the controllable feature 326. The QUBO instance 320 also includes the non-controllable structure feature 328.

The method 700 includes using the first controllable features and the first uncontrollable structure feature of the received plurality of QUBO instances to train a QUBO generation machine-learning (ML) model to generate a QUBO instance (720). For example, as previously described the QUBO instances 310, 320 and 330 are used to train the QUBO generation ML model 340, which can be a GAN model, so that it become the trained QUBO generation ML model 350. The training process may be as described in FIGS. 3B-3D.

The method 700 includes receiving an existing QUBO instance that includes at least second controllable features and their corresponding feature values and a second uncontrollable structure feature that defines a problem type of the existing QUBO instance (730). For example, as previously described the original QUBO instance 450 is received by the trained QUBO generation ML model 420.

The method 700 includes receiving a QUBO modification dataset that specifies modifications that are to be made to one or more of the corresponding feature values of one or more of the second controllable features (740). For example, as previously described the QUBO modifications 462 is received by the trained QUBO generation ML model 420. The QUBO modifications 462 may be entered using the user interface 480.

The method 700 includes generating, by the trained QUBO generation ML model, a modified QUBO instance that is a modification of the existing QUBO instance and that includes the one or more of the second one or more controllable features whose corresponding feature values have been modified, other second controllable features whose corresponding feature values were not modified, and the second uncontrollable structure feature (740). For example, as previously described the trained QUBO generation ML model 420 generates the generated modified QUBO instance 460.

### D. Further Example Embodiments

Following are some further example embodiments. These are presented only by way of example and are not intended to limit the scope of this disclosure or the claims in any way.

Embodiment 1. A method, comprising: receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances; using the first controllable features and the first uncontrollable structure feature of the received plurality of QUBO instances to train a QUBO generation machine-learning (ML) model to generate a QUBO instance; receiving a QUBO feature set that includes second controllable features and their corresponding feature values and a second uncontrollable structure feature that defines a problem type of a new QUBO instance; and generating, by the trained QUBO generation ML model, the new QUBO instance that includes the second controllable features and their corresponding feature values and the second uncontrollable structure feature.

Embodiment 2. The method as recited in embodiment 1, wherein the first controllable features and the second controllable features include one or more of a QUBO size feature, a QUBO problem difficulty feature, a QUBO coefficient interdependency feature, and a QUBO variable connectivity feature.

Embodiment 3. The method as recited in embodiments 1-2, wherein the QUBO generation ML model is a Generative Adversarial Network (GAN).

Embodiment 4. The method as recited in any of embodiments 1-3, wherein using the first controllable features and the first uncontrollable structure feature of the received plurality of QUBO instances to train the QUBO generation ML model to generate a QUBO instance comprises performing a first step comprising: for each of the first controllable features, generating matching pairs of QUBO instances of the plurality of QUBO instances that both include a given one of the first controllable features; mapping each of the first controllable features and their matching pairs into a first latent vector space; mapping each of the first controllable features and their matching pairs from the first latent vector space into a second latent vector space using a first set of encoders; and determining a loss value for each of the first controllable features.

Embodiment 5. The method as recited in any of embodiments 1-4, wherein the first set of encoders are Fully-Connected Multilayer Perceptrons (MLPs).

Embodiment 6. The method as recited in any of embodiments 1-5, further comprising performing a second step comprising: training a second set of encoders to map received QUBO features and their corresponding values into the second latent vector space.

Embodiment 7. The method as recited in any of embodiments 1-6, wherein generating, by the trained QUBO generation ML model, the new QUBO instance comprises: providing the second controllable features and their corresponding feature values to an encoder set, wherein there is a separate encoder for each controllable feature; mapping by the encoder set the second controllable features and their corresponding feature values to a latent vector space; and using the second controllable features and their corresponding feature values in the latent vector space to generate the new QUBO instance.

Embodiment 9. A system, comprising hardware and/or software, operable to perform any of the operations, methods, or processes, or any portion of any of these, disclosed herein.

Embodiment 10. A non-transitory storage medium having stored therein instructions that are executable by one or more hardware processors to perform operations comprising the operations of any one or more of embodiments 1-8.

Embodiment 11. A method, comprising: receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances; using the first controllable features and the first uncontrollable structure feature of the received plurality of QUBO instances to train a QUBO generation machine-learning (ML) model to generate a QUBO instance; receiving an existing QUBO instance that includes at least second controllable features and their corresponding feature values and a second uncontrollable structure feature that defines a problem type of the existing QUBO instance; receiving a QUBO modification dataset that specifies modifications that are to be made to one or more of the corresponding feature values of one or more of the second controllable features; and generating, by the trained QUBO generation ML model, a modified QUBO instance that is a modification of the existing QUBO instance and that includes the one or more of the second one or more controllable features whose corresponding feature values have been modified, other second controllable features whose corresponding feature values were not modified, and the second uncontrollable structure feature.

Embodiment 12. The method as recited in embodiment 11, wherein the first controllable features and the second controllable features include one or more of a QUBO size feature, a QUBO problem difficulty feature, a QUBO coefficient interdependency feature, and a QUBO variable connectivity feature.

Embodiment 13. The method as recited in embodiments 11-12, wherein the QUBO generation ML model is a Generative Adversarial Network (GAN).

Embodiment 14. The method as recited in any of embodiments 11-13, wherein using the first controllable features and the first uncontrollable structure feature of the received plurality of QUBO instances to train the QUBO generation ML model to generate a QUBO instance comprises performing a first step comprising: for each of the first controllable features, generating matching pairs of QUBO instances of the plurality of QUBO instances that both include a given one of the first controllable features; mapping each of the first controllable features and their matching pairs into a first latent vector space; mapping each of the first controllable features and their matching pairs from the first latent vector space into a second latent vector space using a first set of encoders; and determining a loss value for each of the first controllable features.

Embodiment 15. The method as recited in any of embodiments 11-14, wherein the first set of encoders are Fully-Connected Multilayer Perceptrons (MLPs).

Embodiment 16. The method as recited in any of embodiments 11-15, further comprising performing a second step comprising: training a second set of encoders to map received QUBO features and their corresponding values into the second latent vector space.

Embodiment 17. The method as recited in any of embodiments 11-16, wherein the QUBO modification dataset is entered by use of a user interface that includes one of more user interface elements that allow a user to modify the one or more of the corresponding feature values of the one or more of the second controllable features.

Embodiment 18. The method as recited in any of embodiments 11-17, wherein the existing QUBO instance is reconstructed into a latent vector space prior to the generation of the modified QUBO instance.

Embodiment 19. A non-transitory storage medium having stored therein instructions that are executable by one or more hardware processors to perform operations comprising the operations of any one or more of embodiments 11-18.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

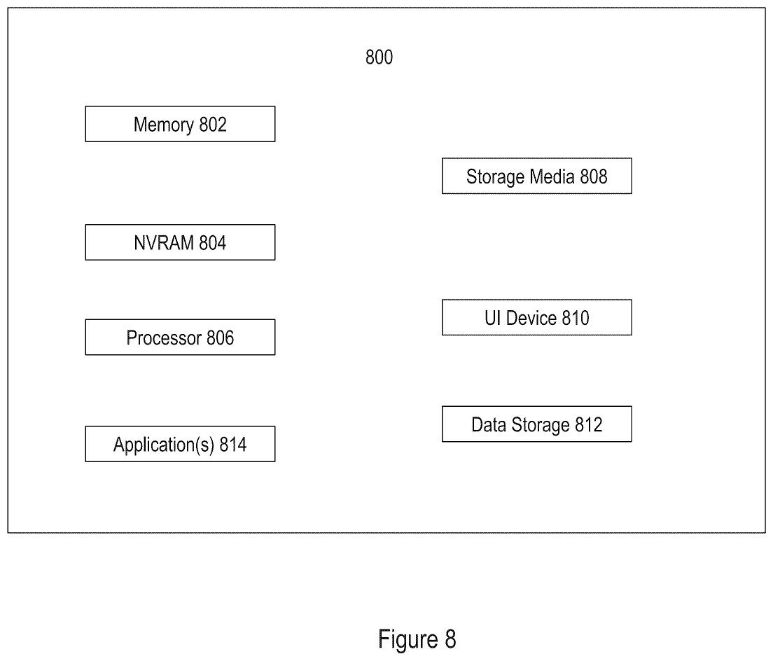

With reference briefly now to FIG. 8, any one or more of the entities disclosed, or implied, by any of the previously discussed figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances;
using the first controllable features and the first uncontrollable structure feature of the received plurality of QUBO instances to train a QUBO generation machine-learning (ML) model to generate a QUBO instance;
receiving a QUBO feature set that includes second controllable features and their corresponding feature values and a second uncontrollable structure feature that defines a problem type of a new QUBO instance; and
generating, by the trained QUBO generation ML model, the new QUBO instance that includes the second controllable features and their corresponding feature values and the second uncontrollable structure feature.

2. The method of claim 1, wherein the first controllable features and the second controllable features include one or more of a QUBO size feature, a QUBO problem difficulty feature, a QUBO coefficient interdependency feature, and a QUBO variable connectivity feature.

3. The method of claim 1, wherein the QUBO generation ML model is a Generative Adversarial Network (GAN).

4. The method of claim 1, wherein using the first controllable features and the first uncontrollable structure feature of the received plurality of QUBO instances to train the QUBO generation ML model to generate a QUBO instance comprises performing a first step comprising:
for each of the first controllable features, generating matching pairs of QUBO instances of the plurality of QUBO instances that both include a given one of the first controllable features;
mapping each of the first controllable features and their matching pairs into a first latent vector space;
mapping each of the first controllable features and their matching pairs from the first latent vector space into a second latent vector space using a first set of encoders; and
determining a loss value for each of the first controllable features.

5. The method of claim 4, wherein the first set of encoders are Fully-Connected Multilayer Perceptrons (MLPs).

6. The method of claim 4, further comprising performing a second step comprising:
training a second set of encoders to map received QUBO features and their corresponding values into the second latent vector space.

7. The method of claim 1, wherein generating, by the trained QUBO generation ML model, the new QUBO instance comprises:
providing the second controllable features and their corresponding feature values to an encoder set, wherein there is a separate encoder for each controllable feature;
mapping by the encoder set the second controllable features and their corresponding feature values to a latent vector space; and
using the second controllable features and their corresponding feature values in the latent vector space to generate the new QUBO instance.

8. A non-transitory storage medium having stored therein instructions that are executable by one or more hardware processors to perform operations comprising:
receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances;
using the first controllable features and the first uncontrollable structure feature of the received plurality of QUBO instances to train a QUBO generation machine-learning (ML) model to generate a QUBO instance;
receiving a QUBO feature set that includes second controllable features and their corresponding feature values and a second uncontrollable structure feature that defines a problem type of a new QUBO instance; and
generating, by the trained QUBO generation ML model, the new QUBO instance that includes the second controllable features and their corresponding feature values and the second uncontrollable structure feature.

9. The non-transitory storage medium as recited in claim 8, wherein the first controllable features and the second controllable features include one or more of a QUBO size feature, a QUBO problem difficulty feature, a QUBO coefficient interdependency feature, and a QUBO variable connectivity feature.

10. The non-transitory storage medium as recited in claim 8, wherein the QUBO generation ML model is a Generative Adversarial Network (GAN).

11. The non-transitory storage medium as recited in claim 8, wherein using the first controllable features and the first uncontrollable structure feature of the received plurality of QUBO instances to train the QUBO generation ML model to generate a QUBO instance comprises performing a first step comprising:
for each of the first controllable features, generating matching pairs of QUBO instances of the plurality of QUBO instances that both include a given one of the first controllable features;
mapping each of the first controllable features and their matching pairs into a first latent vector space;
mapping each of the first controllable features and their matching pairs from the first latent vector space into a second latent vector space using a first set of encoders; and
determining a loss value for each of the first controllable features.

12. The non-transitory storage medium as recited in claim 11, further comprising performing a second step comprising:
training a second set of encoders to map received QUBO features and their corresponding values into the second latent vector space.

13. The non-transitory storage medium as recited in claim 8, wherein generating, by the trained QUBO generation ML model, the new QUBO instance comprises:
providing the second controllable features and their corresponding feature values to an encoder set, wherein there is a separate encoder for each controllable feature;
mapping by the encoder set the second controllable features and their corresponding feature values to a latent vector space; and
using the second controllable features and their corresponding feature values in the latent vector space to generate the new QUBO instance.

14. A method, comprising:
receiving a plurality of Quadratic Unconstrained Binary Optimization (QUBO) instances, each of the plurality of QUBO instances including at least first controllable features and their corresponding feature values and a first uncontrollable structure feature that defines a problem type of each of the plurality of QUBO instances;
using the first controllable features and the first uncontrollable structure feature of the received plurality of QUBO instances to train a QUBO generation machine-learning (ML) model to generate a QUBO instance;
receiving an existing QUBO instance that includes at least second controllable features and their corresponding feature values and a second uncontrollable structure feature that defines a problem type of the existing QUBO instance;
receiving a QUBO modification dataset that specifies modifications that are to be made to one or more of the corresponding feature values of one or more of the second controllable features; and
generating, by the trained QUBO generation ML model, a modified QUBO instance that is a modification of the existing QUBO instance and that includes the one or more of the second one or more controllable features whose corresponding feature values have been modified, other second controllable features whose corresponding feature values were not modified, and the second uncontrollable structure feature.

15. The method of claim 14, wherein the first controllable features and the second controllable features include one or more of a QUBO size feature, a QUBO problem difficulty feature, a QUBO coefficient interdependency feature, and a QUBO variable connectivity feature.

16. The method of claim 14, wherein the QUBO generation ML model is a Generative Adversarial Network (GAN).

17. The method of claim 14, wherein using the first controllable features and the first uncontrollable structure feature of the received plurality of QUBO instances to train the QUBO generation ML model to generate a QUBO instance comprises performing a first step comprising:
for each of the first controllable features, generating matching pairs of QUBO instances of the plurality of QUBO instances that both include a given one of the first controllable features;
mapping each of the first controllable features and their matching pairs into a first latent vector space;
mapping each of the first controllable features and their matching pairs from the first latent vector space into a second latent vector space using a first set of encoders; and
determining a loss value for each of the first controllable features.

18. The method of claim 17, further comprising performing a second step comprising:
training a second set of encoders to map received QUBO features and their corresponding values into the second latent vector space.

19. The method of claim 14, wherein the QUBO modification dataset is entered by use of a user interface that includes one of more user interface elements that allow a user to modify the one or more of the corresponding feature values of the one or more of the second controllable features.

20. The method of claim 14, wherein the existing QUBO instance is reconstructed into a latent vector space prior to the generation of the modified QUBO instance.
